(19) United States
(12) Patent Application Publication
(10) Pub. No.: US 2007/0104405 A1
(43) Pub. Date: May 10, 2007

(54) Bearing device for bicycles

(76) Inventor: Chia-Wei Lin, Tan-Zi Hsiang (TW)

Correspondence Address: CHARLES E. BAXLEY, ESQ., 90 JOHN STREET, THIRD FLOOR, NEW YORK, NY, 10038, US

(21) Appl. No.: 11/271,661

(22) Filed: Nov. 10, 2005

(51) Int. Cl. F16C 13/00

(52) U.S. Cl. 384/545

(57) ABSTRACT

A bearing device for bicycles includes a first race with a support ring connected thereto and a plurality of beads connected by a ring are received in a space enclosed by the first race and the support ring. An annular engaging recess is defined in an inner periphery of the first race. A second race having an L-shaped cross section includes a horizontal flange and a vertical flange which is engaged with the annular engaging recess and the support ring is in contact with the horizontal flange. A seal ring is located between the horizontal flange of the second race and the support ring.

### FIELD OF THE INVENTION

The present invention relates to a bearing device on each of two ends of the head tube of a bicycle and the bearing device is easily to be assembled and disassembled.

### BACKGROUND OF THE INVENTION

In order to allow the handlebar stem to be rotatable relative to the head tube of the bicycle frame, a bearing device is mounted on a top end of the head tube and mounted to the handlebar stem so that the handlebar stem is rotatable relative to the head tube. Similarly, another bearing device is connected to a lower end of the head tube and the steerer tube extends through the bearing device on the lower end of the head tube so that the front wheel connected to the steerer tube can turn relative to the head tube. The conventional bearing device generally includes a bush which is pressed to combine all of the parts of the bearing device. Although the bush combine the parts of the bearing device to prevent the parts from being separated from each other. The bush also limits the user to maintain the bearing device because the bush is installed to the bearing device by pressing so that it is difficult to maintain the beads in the bearing device when needed or to remove dust or sand in the bearing device.

The present invention intends to provide a bearing device when is easily to be assembled and includes a sealing ring to prevent sand or dust form entering the bearing device.

### SUMMARY OF THE INVENTION

The present invention relates to a bearing device for bicycles and the bearing device comprises a first race having a first portion and a second portion, wherein the first portion has a first groove defined in an inner periphery thereof and an annular engaging recess is defined in an inner periphery of the second portion. A support ring has a second groove defined in an outer periphery thereof and located in a space enclosed by the first race so as to receive a plurality of beads connected by a ring in a space enclosed by the first groove and the second groove. A second race has an L-shaped cross section and includes a horizontal flange and a vertical flange which is engaged with the annular engaging recess and the support ring is in contact with the horizontal flange.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bearing device of the present invention;

FIG. 2 is a perspective view to show the bearing device, partly remved, of the present invention;

FIG. 3 shows that two bearing devices of the present invention are connected to two ends of the bicycle head tube;

FIG. 4 is a cross sectional view to show that the bearing device is connected with another head tube, and

FIG. 5 is a cross sectional view to show that the bearing device is connected with yet another head tube.

### DETAILED DESCRIPTION OF THE PREFERRED EMBODIMENT

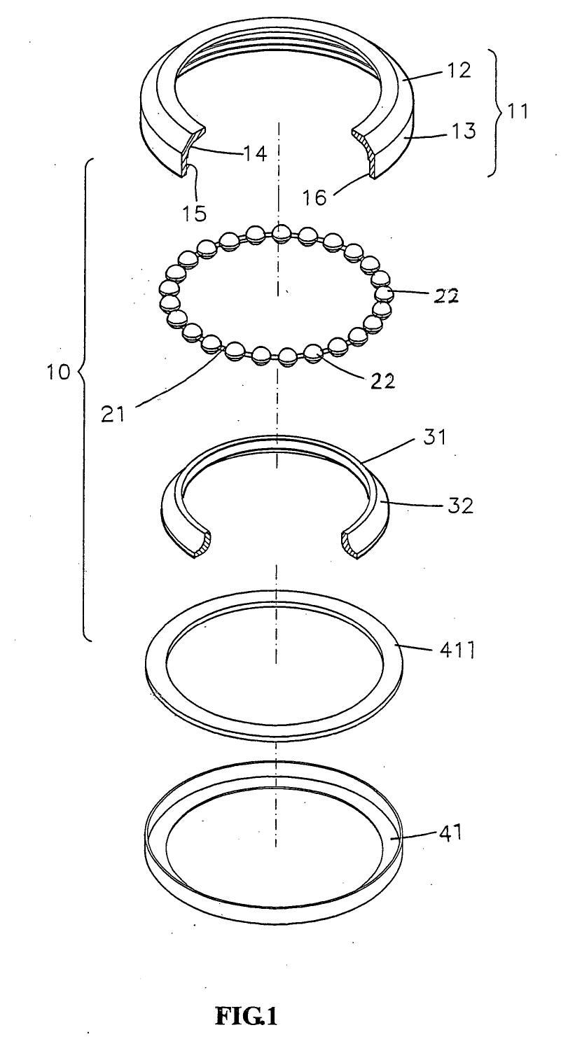

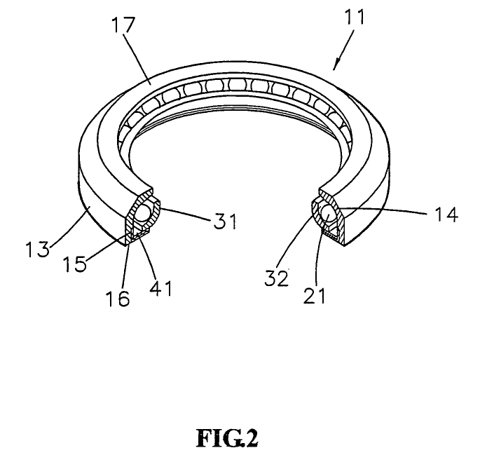

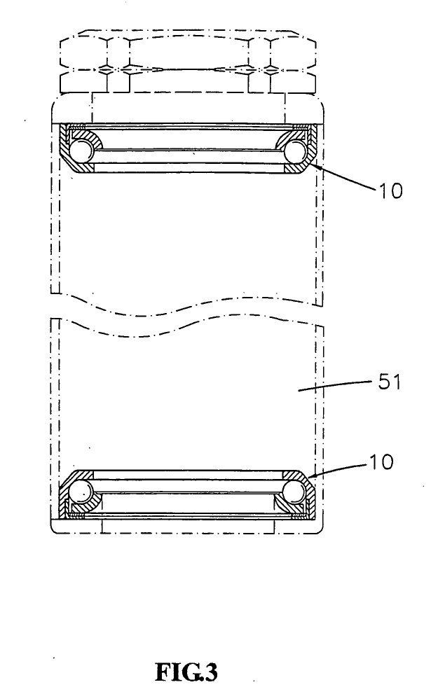

Referring to FIGS. 1 to 3, the bearing device 10 of the present invention comprises a first race 11 having a first portion 12 and a second portion 13 which is integrally connected to the first portion 12. The first portion 12 has a first groove 14 defined in an inner periphery of the first portion 12 and an annular engaging recess 15 is defined in an inner periphery of the second portion 13. The first portion 12 has an inclined outer periphery so that the assembler can easily identify the direction of installation.

A support ring 31 has a second groove 32 defined in an outer periphery thereof and the support ring 31 is located in a space enclosed by the first race 11. A plurality of beads 22 connected by a ring 21 are received in a space enclosed by the first groove 14 and the second groove 31. A second race 41 has an L-shaped cross section and includes a horizontal flange and a vertical flange which is engaged with the annular engaging recess 15 and the support ring is in contact with the horizontal flange. By the second race 41, the beads 22 are well positioned in the space between the first groove 14 and the second groove 31.

A plastic seal ring 411 is located between the horizontal flange of the second race 41 and the support ring 31 so as to prevent foreign objects such as sands from entering the space where the beads 22 are received.

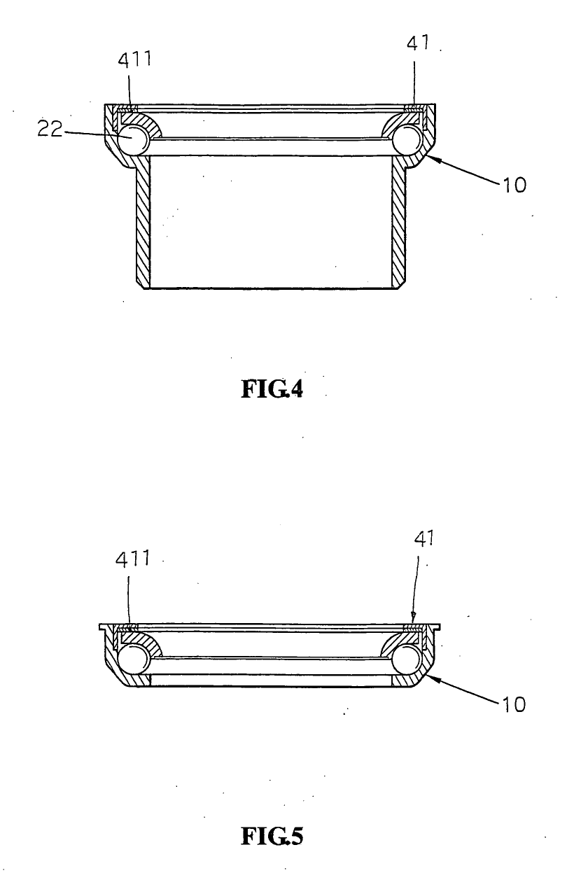

FIGS. 4 and 5 show that the bearing device 10 of the present invention can be cooperated with different types of head tubes wherein the first race 11 is made integrally with the head tubes.

The inclined outer periphery of the first portion 12 provides an easy and obvious way to identify the orientation of the bearing device 10 and there is no bush as described in the conventional bearing device used in the bearing device 10 of the present invention so that the bearing device 10 can be easily assembled and dis-assembled for maintenance. The seal ring 411 effectively prevents the beads 22 from being in contact with sands or water so that the bearing device 10 has a longer term of use.

While we have shown and described the embodiment in accordance with the present invention, it should be clear to those skilled in the art that further embodiments may be made without departing from the scope of the present invention.

What is claimed is:

1. A bearing device for bicycles comprising:
a first race having a first portion and a second portion, the first portion having a first groove defined in an inner periphery of the first portion, an annular engaging recess defined in an inner periphery of the second portion;
a support ring having a second groove defined in an outer periphery thereof, the support ring located in a space enclosed by the first race;
a plurality of beads connected by a ring and received in a space enclosed by the first groove and the second groove, and
a second race having an L-shaped cross section and including a horizontal flange and a vertical flange which is engaged with the annular engaging recess and the support ring being in contact with the horizontal flange.

2. The bearing device as claimed in claim 1, wherein a seal ring located between the horizontal flange of the second race and the support ring.

3. The bearing device as claimed in claim 1, wherein the first portion has an inclined outer periphery.
